(19) United States
(12) Patent Application Publication
(10) Pub. No.: US 2022/0078520 A1
(43) Pub. Date: Mar. 10, 2022

(54) METHOD, COMPUTER PROGRAM AND BROADCASTING SYSTEM FOR PROVIDING REVIEW CONTENT FOR COMMERCE CONTENT

(71) Applicant: SK STOA CO., LTD., Seoul (KR)

(72) Inventor: Dae Ho MYOUNG, Seoul (KR)

(73) Assignee: SK STOA CO., LTD., Seoul (KR)

(21) Appl. No.: 17/466,375

(22) Filed: Sep. 3, 2021

(30) Foreign Application Priority Data
Sep. 4, 2020 (KR) 10-2020-0113219

(51) Int. Cl. H04N 21/4782; H04N 21/431; H04N 21/858; H04N 21/643; G06Q 30/02; G06F 16/435; G06F 16/45; G06F 16/2457

(52) U.S. Cl. CPC H04N 21/4782; H04N 21/4312; H04N 21/858; H04N 21/64322; G06F 16/24578; G06Q 30/0245; G06F 16/435; G06F 16/45; G06Q 30/0201

(57) ABSTRACT

A method of providing review data for commerce content includes generating, by a media providing server, first broadcast output data including first broadcast sales information based on first broadcasting store identification information corresponding to a user request signal received from a set-top box, receiving, by the media providing server, review source data corresponding to the first broadcasting store identification information from a data server to generate review data, generating, by the media providing server, review-related UI data based on the review data according to a preset output algorithm, and generating, by the media providing server, second broadcast output data by synthesizing or combining the review-related UI data with the first broadcast output data, and transmitting the second broadcast output data to the set-top box.

### CROSS-REFERENCE TO RELATED APPLICATION

This application is based on and claims priority under 35 U.S.C. § 119 to Korean Patent Application No. 10-2020-0113219, filed on Sep. 4, 2020, in the Korean Intellectual Property Office, the disclosure of which is incorporated by reference herein in its entirety.

### BACKGROUND

### 1. Field

One or more embodiments relate to a method, a computer program, and a broadcasting system for providing review content for commerce content based on a set-top box connected to a TV.

### 2. Description of the Related Art

With the recent development of TV technology and digital technology, various information is being delivered to viewers through TV. For example, TV home shopping, which provides shopping information through TV, provides various information according to technological change.

With the recent commercialization of digital-based digital television technology, various content may be provided through networks such as the Internet connected to each home, and an Internet Protocol Television (IPTV) service is a representative example.

In the IPTV service, various services may be provided to IPTV service subscribers through a set-top box installed in a designated space such as a home, and among them, a shopping broadcasting service (or commercial broadcasting) provided through a commerce channel may be provided.

In the case of a commerce business operator producing a shopping broadcasting service, a commerce channel (i.e., a shopping broadcasting service) may be scheduled in a correspondingly granted/promised slot by paying a certain amount.

Accordingly, when an IPTV service subscriber selects a promised channel on a set-top box, the set-top box receives a commerce channel regularly scheduled for that channel and outputs the commerce channel through a TV connected to the set-top box, so that the IPTV service subscriber may watch the commerce channel and use the shopping broadcasting service. However, this has a limit in delivering various shopping information according to a user's request and improving convenience such as checking shopping information and ordering.

In controlling the output of the IPTV through the set-top box, a network connected to the set-top box may be overloaded according to the demand for linking with various content such as real-time data according to a user input.

In addition, because large-capacity broadcasting content is received from servers outside the set-top box, the need for effective and rapid display of such large-capacity data is on the rise.

### SUMMARY

One or more embodiments include a method, a computer program, and a broadcasting system for providing review content for commerce content based on a set-top box connected to a TV capable of promoting a user's purchase desire and effectively advertising commerce content while distributing a data load on a network by using a server distinct from the set-top box.

Additional aspects will be set forth in part in the description which follows and, in part, will be apparent from the description, or may be learned by practice of the presented embodiments of the disclosure.

According to one or more embodiments, a method of providing review data for commerce content includes generating, by a media providing server, first broadcast output data including first broadcast sales information based on first broadcasting store identification information corresponding to a user request signal received from a set-top box, generating, by the media providing server, review data by receiving review source data corresponding to the first broadcasting store identification information from a data server, generating, by the media providing server, review-related UI data based on the review data according to a preset output algorithm, and generating, by the media providing server, second broadcast output data by synthesizing the review-related UI data with the first broadcast output data and transmitting the second broadcast output data to the set-top box.

In at least one variant, the review data includes first review data and second review data according to whether there is the review source data, wherein the generating of the review data may include obtaining, by a review providing server, review source data for the first broadcast sales information from a user terminal and transmitting the review source data to the data server; determining, by the media providing server, whether there is the review source data by transmitting a search signal to the data server; and generating, by the media providing server, the first review data by processing the review source data when there is the review source data, and generating the second review data when there is no review source data.

In another variant, the review source data may include at least one item of user identification information, age information, gender information, input time information, and a user evaluation, and the generating of the first review data may include: categorizing each item of the review source data and classifying the items according to a preset classification criterion; and generating the first review data including at least one of rating information, a review participation generation ratio, a rating ratio by participation generation, and a user evaluation according to a result of the classifying.

In further another variant, the generating of the review-related UI data may include generating first UI data for providing review information about the first broadcast sales information based on the first review data, and determining and storing different output areas according to the type of the first review data; and linking the first UI data with first time code pre-stored in the data server.

In another variant, the generating of the first UI data may include: comparing the first review data with a first output area in which the first review data is output on the first UI data; generating pieces of first sub-review data by dividing the first review data when a first output size of the first review data exceeds a second output size of the first output area as a result of the comparing; and assigning an output rank to each of the pieces of first sub-review data so that the pieces of first sub-review data are sequentially output through an output device.

In another variant, the generating of the review-related UI data includes: generating second UI data for inducing review writing based on the second review data; and linking the second UI data with second time code pre-stored in the data server, and may further include after the generating of the second broadcast output data: receiving, by the set-top box, a request signal corresponding to a user input for the second UI data; and obtaining, by the review providing server, review source data for the first broadcast sales information from the user.

In another variant, the generating of the first broadcast output data may include transmitting, by the media providing server, the first broadcasting store identification information to the data server; searching for, by the data server, first image identification information and first detailed product information corresponding to the first broadcasting store identification information, receiving, by the media providing server, at least one of the first image identification information and the first detailed product information according to a result of the searching from the data server, and generating, by the media providing server, the first broadcast output data based on at least one of the first image identification information and the first detailed product information.

In another variant, the above-described methods may be stored as a computer program in a computer-readable recording medium to be executed using a computer.

According to one or more embodiments, a system for providing review data for commerce content includes a media providing server including a processor and a communication unit capable of communicating with a set-top box connected to an output device; and a data server communicating with the set-top box and the media providing server, wherein the processor generates first broadcast output data including first broadcast sales information based on first broadcasting store identification information corresponding to a user request signal received from the set-top box, receives review source data corresponding to the first broadcasting store identification information from the data server and generates review data, generates review-related UI data based on the review data according to a preset output algorithm, generates second broadcast output data by synthesizing the review-related UI data with the first broadcast output data, and transmits the second broadcast output data to the set-top box.

In at least one variant, the review data includes first review data and second review data according to whether there is the review source data, and the system further includes a review providing server communicating with the set-top box, the media providing server, and the data server, wherein the review providing server may obtain review source data for the first broadcast sales information from a user terminal and transmit the review source data to the data server, and the processor may transmit a search signal to the data server to determine whether there is the review source data, may generate the first review data by processing the review source data when there is the review source data, and may generate the second review data when there is no review source data.

In another variant, the review source data may include at least one item of user identification information, age information, gender information, input time information, and a user evaluation, wherein the processor may categorize each item of the review source data and classify the items according to a preset classification criterion, and may generate the first review data including at least one of rating information, a review participation generation ratio, a rating ratio by participation generation, and a user evaluation according to a result of the classifying.

In another variant, the processor may generate first UI data for providing review information about the first broadcast sales information based on the first review data, may determine and store different output areas according to the type of the first review data, and may link the first UI data with first time code pre-stored in the data server.

In another variant, the processor may compare the first review data with a first output area in which the first review data is output on the first UI data, may generate pieces of first sub-review data by dividing the first review data when a first output size of the first review data exceeds a second output size of the first output area as a result of the comparing, and may assign an output rank to each of the pieces of first sub-review data so that the pieces of first sub-review data are sequentially output through an output device.

In another variant, the processor may generate second UI data for inducing review writing based on the second review data, and may link the second UI data with second time code pre-stored in the data server. After the processor generates the second broadcast output data, the set-top box may receive a request signal corresponding to a user input for the second UI data, and the review providing server may obtain review source data for the first broadcast sales information from the user.

In another variant, in the first broadcast output data, the processor may transmit the first broadcasting store identification information to the data server, the data server may search for first image identification information and first detailed product information corresponding to the first broadcasting store identification information, and the processor may receive at least one of the first image identification information and the first detailed product information according to a result of the searching from the data server, and may generate the first broadcast output data based on at least one of the first image identification information and the first detailed product information.

According to one or more embodiments, a method of providing review data for commerce content includes steps of (i) generating, with a media providing server, first broadcast output data including first broadcast sales information based on first broadcasting store identification information corresponding to a user request signal received from a set-top box, (ii) receiving, at the media providing server, review source data corresponding to the first broadcasting store identification information from a data server and generating review data, (iii) generating, with the media providing server, review-related user interface (UI) data based on the review data according to a preset output algorithm based on absence or presence of the review source data, and (iv) generating, with the media providing server, second broadcast output data by combining the review-related UI data with the first broadcast output data, and transmitting the second broadcast output data to the set-top box.

In at least one variant, the review data comprises first review data and second review data based on absence or presence of the review source data in the data server.

The step of generating the review data further includes (i) obtaining, with a review providing server, the review source data for the first broadcast sales information from a user terminal and transmitting the review source data to the data server, (ii) determining, with the media providing server, absence or presence of the review source data by transmitting a search signal to the data server, and (iii) generating, by the media providing server, the first review data by processing the review source data based on presence of the review source data, and generating the second review data based on absence of the review source data.

In another variant, the review source data further comprises a set of information that include user identification information, age information, gender information, input time information, a user evaluation, or a combination thereof. The step of generating the first review data further comprises categorizing each information of the review source data and classifying each information according to a preset classification criterion, and generating the first review data including rating information, a review participation generation ratio, a rating ratio by participation generation, a user evaluation, or a combination thereof, according to classification of each information.

In further another variant, generating the review-related user interface (UI) data further comprises (i) generating first UI data that provides review information about the first broadcast sales information based on the first review data, and determining and storing different output areas according to a type of the first review data, and (ii) linking the first UI data with first time code pre-stored in the data server such that the first UI data is output as the first broadcast output data at a time set according to the first time code.

In another variant, generating of the first UI data further comprises (i) comparing the first review data with a first output area in which the first review data is displayed on the first UI data, (ii) generating pieces of first sub-review data by slicing the first review data when a first output size of the first review data exceeds a second output size of the first output area based on comparison, (iii) assigning an output rank to each of the pieces of first sub-review data, and (iv) sequentially outputting, based on an assigned output rank, the pieces of first sub-review data through an output device.

In another variant, generating the review-related user interface (UI) data further comprises steps of generating second UI data for prompting review writing based on the second review data, and linking the second UI data with second time code pre-stored in the data server such that the second UI data is output as the first broadcast output data at a time set according to the second time code.

In another variant, after generating the second broadcast output data, the method further includes steps of receiving, at the set-top box, a request signal corresponding to a user input for the second UI data, and obtaining, with the review providing server, review source data for the first broadcast sales information from the user.

In another variant, generating the first broadcast output data further includes steps of (i) transmitting, with the media providing server, the first broadcasting store identification information to the data server, (ii) searching at the data server, first image identification information and first detailed product information corresponding to the first broadcasting store identification information, (iii) receiving, at the media providing server, the first image identification information, the first detailed product information, or both according to a result of the searching from the data server, and (iv) generating, by the media providing server, the first broadcast output data based on the first image identification information, the first detailed product information, or both.

According to one or more embodiments, a commerce content broadcasting system includes a media providing server including a processor and a communication unit capable of communicating with a set-top box connected to an output device, and a data server communicating with the set-top box and the media providing server. The processor is configured to (i) generate first broadcast output data including first broadcast sales information based on first broadcasting store identification information corresponding to a user request signal received from the set-top box, (ii) receive review source data corresponding to the first broadcasting store identification information from the data server and generate review data, (iii) generate review-related UI data based on the review data, and (iv) generate second broadcast output data by combining the review-related UI data with the first broadcast output data, and (v) output the second broadcast output data to the set-top box via the communication unit.

In at least one variant, the review data comprises first review data and second review data based on presence or absence of the review source data in the data server.

In another variant, a review providing server communicating with the set-top box, the media providing server, and the data server. The review providing server obtains the review source data for the first broadcast sales information from a user terminal and transmits the review source data to the data server.

In further another variant, the processor is further configured to transmit a search signal to the data server to determine presence or absence of the review source data, generate the first review data by processing the review source data based on presence of the review source data, and generate the second review data based on absence of the review source data.

In another variant, the review source data comprises user identification information, age information, gender information, input time information, a user evaluation, or a combination thereof. The processor is further configured to categorize each information of the review source data and classify each information according to a preset classification criterion and generate the first review data including rating information, a review participation generation ratio, a rating ratio by participation generation, a user evaluation, or a combination thereof, according to classification of each information.

In another variant, the processor is further configured to generate first UI data for providing review information about the first broadcast sales information based on the first review data, determine and store different output areas according to a type of the first review data, and link the first UI data with first time code pre-stored in the data server such that the first UI data is output as the first broadcast output data at a time set according to the first time code.

In another variant, the processor is further configured to compare the first review data with a first output area in which the first review data is output on the first UI data, slice the first review data to generate pieces of first sub-review data when a first output size of the first review data exceeds a second output size of the first output area, assign an output rank to each of the pieces of first sub-review data, and sequentially output, based on an assigned output rank, the pieces of first sub-review data through an output device.

In another variant, the processor is further configured to generate second UI data for prompting review writing based on the second review data, and link the second UI data with second time code pre-stored in the data server such that the second UI data is output as the first broadcast output data at a time set according to the second time code.

In another variant, after the processor generates the second broadcast output data, the set-top box receives a request signal corresponding to a user input for the second UI data. The review providing server obtains review source data for the first broadcast sales information from the user.

In another variant, in the first broadcast output data, the processor transmits the first broadcasting store identification information to the data server. The data server searches for first image identification information and first detailed product information corresponding to the first broadcasting store identification information. The processor receives the first image identification information, the first detailed product information, or both from the data server, and generates the first broadcast output data based on the first image identification information, the first detailed product information, or both.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view of a configuration of a broadcasting system according to an embodiment;

FIG. 2 is a detailed view of a partial configuration of a broadcasting system according to an embodiment;

FIG. 3 is a flowchart illustrating an operation of a broadcasting system according to an embodiment in terms of data transmission/reception between servers;

FIG. 4 is a flowchart illustrating an operation of a broadcasting system according to an embodiment;

FIG. 5 is a flowchart illustrating in more detail generating review data according to an embodiment;

FIG. 6 is a flowchart illustrating in more detail generating review-related UI data according to an embodiment;

FIG. 7 is a flowchart illustrating in more detail generating review-related UI data according to another embodiment;

FIG. 8 is an exemplary view of output data for commerce content for broadcasting generated by a broadcasting system according to an embodiment;

FIG. 9 is an exemplary view of output data for commerce content for broadcasting generated by a broadcasting system according to another embodiment;

FIG. 10 is an exemplary view of output data at one point in time for non-broadcast commerce content generated by a broadcasting system according to an embodiment; and

FIG. 11 is an exemplary view of output data at another point in time for non-broadcast commerce content generated by a broadcasting system according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Since the disclosure may have diverse modified embodiments, certain embodiments are illustrated in the drawings and are described in the detailed description. Advantages and features of the embodiments, and implementation methods thereof will be clarified through following embodiments described with reference to the accompanying drawings. The disclosure may, however, be embodied in many different forms and should not be construed as limited to the embodiments set forth herein.

Reference will now be made in detail to embodiments, examples of which are illustrated in the accompanying drawings, wherein like reference numerals refer to like elements throughout, and repeated description thereof will be omitted.

It will be understood that although the terms “first,” “second,” etc. may be used herein to describe various components, these components should not be limited by these terms. An expression used in the singular encompasses the expression of the plural, unless it has a clearly different meaning in the context. It will be further understood that the terms “comprises” and/or “comprising” used herein specify the presence of stated features or elements, but do not preclude the presence or addition of one or more other features or elements. Sizes of elements in the drawings may be exaggerated for convenience of explanation. In other words, since sizes and thicknesses of components in the drawings are arbitrarily illustrated for convenience of description, the following embodiments are not limited thereto.

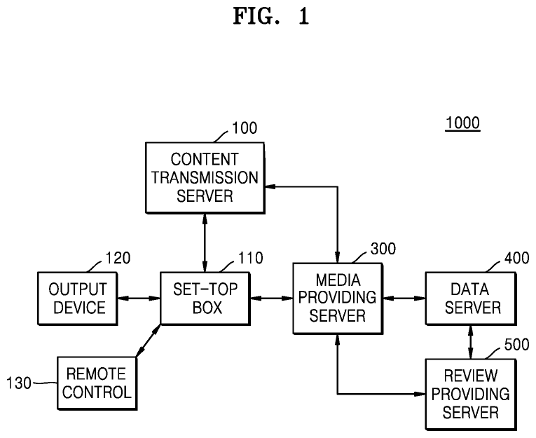

FIG. 1 is a view of a configuration of a broadcasting system 1000 that provides review data for commerce content according to an embodiment.

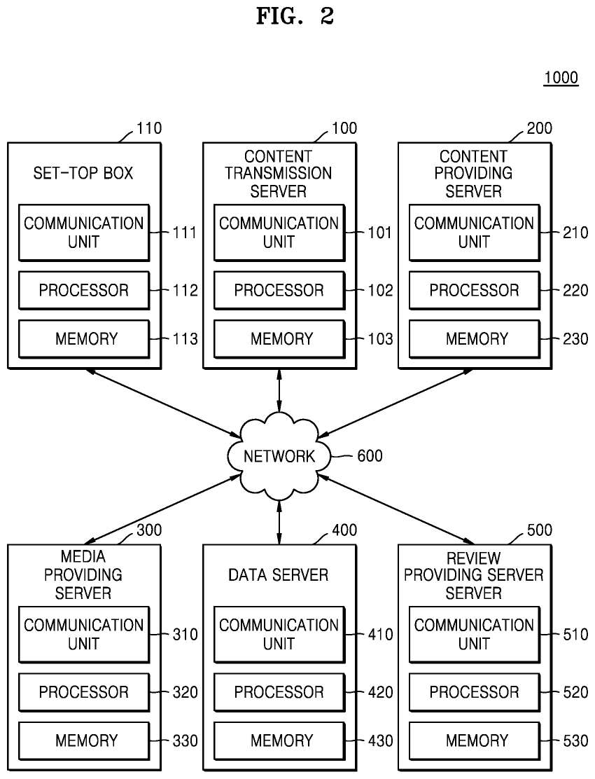

The broadcasting system 1000 may include a media providing server 300, a data server 400, and a review providing server 500. However, the broadcasting system 1000 may also include a content transmission server 100 in some cases. The content transmission server 100, a set-top box 110, the media providing server 300, the data server 400, and the review providing server 500 may be connected to a network 600 to communicate with each other, as shown in FIG. 2. Although the data server 400 and the review providing server 500 are illustrated as separate servers in the disclosure, the operation of the review providing server 500 to be described later below may be performed by the data server 400. However, in some cases, the broadcasting system 1000 may further include a content providing server 200 illustrated in FIG. 2 to be described later below. The content providing server 200 will be further described with reference to FIG. 2 to be described later below.

The broadcasting system 1000 of the disclosure may generate broadcast output data using the media providing server 300, the data server 400, and the review providing server 500, and may provide TV broadcasting by controlling the broadcast output data through the set-top box 110. The set-top box 110 may transmit finally generated broadcast output data to an output device 120 to output TV broadcasting including review content for a product or a broadcasting store according to a request signal corresponding to a user input.

The set-top box 110 is a hardware device necessary for viewing satellite broadcasting or cable broadcasting at home. Data such as satellite broadcasting, cable broadcasting, or Internet broadcasting is transmitted to the set-top box 110 as data processed through compression, modulation, etc. The set-top box 110 performs a process of demodulation and decompression on received data so that the data may be implemented in a terminal such as a TV or the output device 120.

The set-top box 110 may receive a broadcast video from the content transmission server 100.

According to the embodiment, when the broadcasting system 1000 does not include the content transmission server 100, the content transmission server 100 may be, for example, a server of a broadcast provider. However, as described above, the broadcasting system 1000 may include the content transmission server 100. In this case, the content transmission server 100 may transmit content to servers of various broadcast providers. The content transmission server 100 may store content such as a broadcast video suitable for a platform or format of a broadcast provider. The content transmission server 100 may transmit the stored content to the set-top box 110 described above so that content such as a broadcast video is reproduced on the output device 120.

The set-top box 110 may obtain a broadcast channel, a user input regarding broadcasting stores, etc. according to different sales information, and output time information of broadcast output data displayed on the output device 120 through a remote control 130 communicating with the set-top box 110 and transmit them to the data server 400. The output device 120 is a terminal connected to the set-top box 110, and may receive and display pieces of broadcast output data processed and/or received by the set-top box 110 on a display unit (not shown).

The content transmission server 100 may receive data such as a broadcast video from the content providing server 200 (see FIG. 2) through other transmission paths such as a network (e.g., a distributed network, a contents delivery network (CDN)).

The set-top box 110 may transmit, for example, data about a user input obtained through the remote control 130 or the like to the media providing server 300 to receive image identification information of content such as a broadcast video corresponding to the user input from the media providing server 300, and may request broadcast video data (e.g., video on demand (VOD) data) corresponding to the image identification information from the content transmission server 100. According to an embodiment, the set-top box 110 may convert a subscriber's request (e.g., a user input through a remote control) into a control signal and transmit the control signal to the media providing server 300.

The media providing server 300 may drive and control an application based on the control signal transmitted from the set-top box 110. The media providing server 300 may generate application screen data for the application. The application screen data is data about an application screen to be implemented (e.g., displayed) on a screen of the output device 120 such as a TV, and may include content data including review content to be described later below.

The media providing server 300 may transmit the generated application screen data to the set-top box 110. For example, the media providing server 300 may transmit the generated application screen data and image identification information (e.g., reproduced URL information) corresponding to a user's control signal together to the set-top box 110. The media providing server 300 may be, for example, a cloud server.

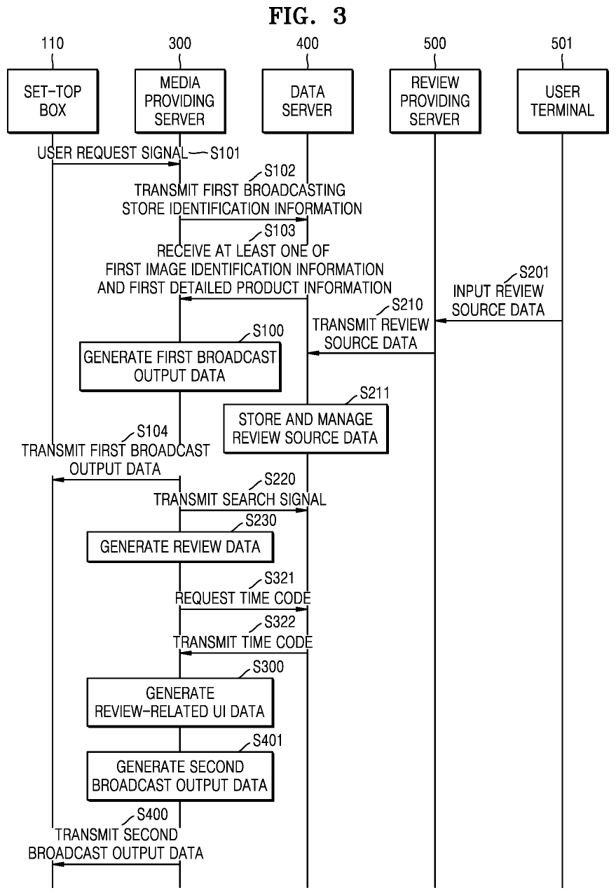

The media providing server 300 may communicate with the content transmission server 100, the data server 400, and the review providing server 500, may receive and generate commerce content corresponding to broadcasting store identification information according to a user's request signal, and may provide TV broadcasting through the set-top box 110 based on broadcast output data generated by combining them. Detailed operations of generating and outputting commerce content including review content using the content transmission server 100, the media providing server 300, the data server 400, and the review providing server 500 will be described in more detail with reference to FIGS. 3 to 7 to be described later below.

For example, a subscriber may select and watch various videos including broadcast sales information for each broadcasting store identification information corresponding to each user input by applying a user input to the set-top box 110 based on an application (or application screen) running in the media providing server 300.

The set-top box 110 may receive data such as a broadcast video from the content transmission server 100 based on communication with the media providing server 300. The set-top box 110 may obtain a broadcast video and VOD data by using image identification information received from the media providing server 300. The set-top box 110 may transmit the obtained content, such as a broadcast video and VOD data, to the output device 120 to be output.

The set-top box 110 may generate broadcast output data to be output through the output device 120 based on data received from the content transmission server 100 and the media providing server 300.

The set-top box 110 may process broadcast output data through a program installed in the set-top box 110. The set-top box 110 may read platform code, an STP (set-top) ID, access information, and the like of the set-top box 110 and generate output data based thereon. The set-top box 110 may control the output data to be output from the output device 120.

The output device 120 is a terminal such as a TV connected to the set-top box 110, and may receive and provide output data processed and/or generated in the set-top box 110. For example, a screen may be displayed according to screen data, and a voice may be output according to voice data. A user terminal such as the output device 120 may be directly connected to the set-top box 110 through a cable or the like. However, the disclosure is not limited thereto, and a user terminal such as the output device 120 may be directly connected to a network, and in this case, may be connected to the set-top box 110 through a network if necessary.

The data server 400 is a server separate from the media providing server 300, and may transmit product information, customer information, order information, schedule information, etc. sold for each broadcasting store (hereinafter, collectively referred to as ‘Detailed Product Information’) to the media providing server 300. The data server 400 is a computing device in which server programs such as Apache Tomcat® and Oracle are installed, and may process server functions. The data server 400 may store product information, production information, and/or deliberation information of content. In addition, the data server 400 may store video identification information and the like, and provide related information to the media providing server 100 in response to a request from the media providing server 100. In some forms, output data generated by the media providing server 300 may be controlled through the data server 400.

The data server 400 may store and manage the image identification information of a broadcast video and the detailed product information described in the previous paragraph for generating content data to be described later below. The image identification information is used to call broadcast video data stored in the content transmission server 100. The set-top box 110 may read image identification information included in output data received from the media providing server 300 to receive a broadcast video from the content transmission server 100 and generate broadcast output data.

The review providing server 500 may obtain review source data for a broadcasting store corresponding to broadcasting store identification information from a user terminal 501 operated by a subscriber (or user) and transmit the review source data to the data server 400. The review source data may include at least one of user identification information, age information, gender information, input time information, and a user evaluation. The review providing server 500 may store the review source data as it is, or store and manage the review source data by processing the review source data according to preset criteria. In the above, the review providing server 500 and the data server 400 have been illustrated and described as separate servers, but according to the embodiment, the two servers, that is, the data server 400 and the review providing server 500 may be implemented as a single server, so that the data server 400 may serve as the review providing server 500.

A network 600 may be defined as one or more data links capable of transmitting and receiving data between electronic devices and/or servers, and may be a wired and/or wireless communication network. For example, the network 600 may be a content delivery network (CDN) capable of efficiently delivering a variety of user-selectable content. As another example, the network 600 may be a wired communication network such as the Internet, or a near-field wireless communication network of at least one of Wi-Fi, Bluetooth®, Bluetooth Low Energy and Zigbee, and ultra-wide band (UWB), but the network 600 is not limited thereto.

According to the present disclosure, by generating broadcast output data including review content using the content transmission server 100, the media providing server 300, the data server 400, and the review providing server 500, a user's purchase desire may be enhanced and effective advertisement for commerce content is possible.

In addition, by generating broadcast output data using the content transmission server 200, the media providing server 300, the data server 400, and the review providing server 500 communicating with the set-top box 110, large-capacity commerce content may be effectively and quickly displayed while distributing a data load on a network.

FIG. 2 is a detailed view of a partial configuration of the broadcasting system 1000 according to an embodiment.

The set-top box 110, the content transmission server 100, the content providing server 200, the media providing server 300, the data server 400, and the review providing server 500 may respectively include communication units 111, 101, 210, 310, 410, and 510, processors 112, 102, 220, 320, 420, and 520, and memories 113, 103, 230, 330, 430, and 530. FIG. 2 shows the content providing server 200 in addition to the configuration of FIG. 1. The content providing server 200 may store original data of a broadcast video, and may manage broadcast video data by providing image identification information for each broadcast video data. The image identification information may be transmitted to the content transmission server 100 and the data server 400 and managed. Thereafter, the media providing server 300 may receive the image identification information from the data server 400 and transmit the image identification information to the set-top box 110, and the set-top box 110 may receive a broadcast video corresponding to the image identification information from the content transmission server 100 without going through the media providing server 300 and/or the data server 400 to obtain broadcast output data.

The communication units 101, 111, 210, 310, 410, and 510 may communicate with various types of external devices and servers according to various types of communication methods. The communication units 101, 111, 210, 310, 410, and 510 of the disclosure may be connected to each other by the network 600 to exchange data with each other, but they are not limited thereto. Some of the components 100, 110, 200, 300, 400, and 500 may be connected to and communicate with each other through separate networks.

The processors 102, 112, 220, 320, 420, and 520, as shown in FIG. 2, by using various programs stored in the memories 103, 113, 230, 330, 430, and 530, may perform an overall control operation for the devices or servers 100, 110, 200, 300, 400, and 500 having respective memories. The processors 102, 112, 220, 320, 420, and 520 may include processing devices such as a microprocessor, a central processing unit (CPU), a processor core, a multiprocessor, an application-specific integrated circuit (ASIC), and a field programmable gate array (FPGA), but are not limited thereto.

The processor 320 of the media providing server 300 may generate first broadcast output data including first broadcast sales information based on first broadcasting store identification information corresponding to a user request signal received from the set-top box 110. In addition, review data may be generated by receiving review source data corresponding to the first broadcasting store identification information from the data server 400. Thereafter, review-related UI data may be generated based on the review data according to a preset output algorithm. Thereafter, by combining the review-related UI data with the first broadcast output data, the second broadcast output data may be generated and transmitted to the set-top box 110.

In this case, review data may include first review data and second review data according to whether there is the review source data.

The processor 520 of the review providing server 500 may obtain review source data for the first broadcast sales information from the user terminal 501 (see FIG. 3) and transmit the review source data to the data server 400.

The processor 320 may transmit a search signal to the data server 400 to determine whether there is the review source data. Because of the search and determination, when there is review source data, the review source data may be processed to generate first review data, and when there is no review source data, second review data may be generated. In this case, review source data may include at least one of user identification information, age information, gender information, input time information, and a user evaluation.

In some forms, the processor 320 according to an embodiment may categorize each item of the review source data and classify the items according to a preset classification criterion. According to a result of the classifying, the first review data including at least one of rating information, a review participation generation ratio, a rating ratio by participating generation, and a user evaluation may be generated.

The processor 320 may generate first UI data for providing review information about first broadcast sales information based on the first review data, and may determine and store different output areas according to the type of the first review data. In addition, the first UI data may be linked with first time code pre-stored in the data server 400. In more detail, the first review data may be compared with a first output area in which the first review data is output on the first UI data. Because of the comparing, when a first output size of the first review data exceeds a second output size of the first output area, the first review data may be divided to generate pieces of first sub-review data. Thereafter, an output order may be assigned to each of the pieces of first sub-review data so that the pieces of first sub-review data are sequentially output through the output device 120.

The processor 320 according to another embodiment may generate second UI data for inviting review writing based on the second review data, and may link the second UI data with second time code pre-stored in the data server 400. After combining the second UI data with the first broadcast output data described above to generate second broadcast output data in operation S400, the set-top box 110 may receive a request signal corresponding to a user input for the second UI data. Thereafter, the review providing server 500 may obtain review source data for first broadcast sales information from a user.

The above-described first broadcast output data may be generated through operations to be described later below. When the processor 320 transmits first broadcasting store identification information to the data server 400, the data server 400 (or the media providing server 300) may search for first image identification information and first detailed product information corresponding to the first broadcasting store identification information. Thereafter, the processor 320 may receive at least one of the first image identification information and the first detailed product information according to a result of the searching from the data server 400. Thereafter, the first broadcast output data may be generated based on at least one of the first image identification information and the first detailed product information.

Data transmission/reception between the content transmission server 100 and the content providing server 200 will be described later below.

The content providing server 200 may register (e.g., get and store) content such as a commerce video to be provided through the broadcasting system 1000 according to an embodiment. In addition, the content providing server 200 may receive meta information of content such as a video from the data server 400 and match the meta information for each content. To this end, the content providing server 200 may be connected to the data server 400, and may exchange various information therewith through communication.

The content providing server 200 may convert content such as a registered video according to a platform or format of each broadcaster and transmit the converted content to the content transmission server 100. However, the disclosure is not limited thereto, and the content providing server 200 may store content and transmit the content to the content transmission server 100, and the content transmission server 100 may convert and store the content according to a platform or format of a broadcaster. This also applies to the following embodiments and modifications thereof.

The content providing server 200 may obtain meta information of content from the data server 400. The meta information may include product information, production information, and/or deliberation information related to the corresponding content. However, in some forms, the content providing server 200 may directly receive and store meta information from a content provider.

The content providing server 200 may transmit data of content such as a video or data of converted content to the content transmission server 100 through a CDN. In addition, the content providing server 200 may receive video identification information of each video from the content transmission server 100. The video identification information may be, for example, reproduced URL information stored in the content transmission server 100. Commerce contents registered in the content providing server 200 may be provided to a subscriber as a video on demand (VOD).

The memories 103, 113, 230, 330, 430, and 530 temporarily or permanently store data processed by the devices or servers 100, 110, 200, 300, 400, and 500 having respective memories. The memories 103, 113, 230, 330, 430, and 530 may include a permanent mass storage device such as random access memory (RAM), read only memory (ROM), and a disk drive, but the scope of the disclosure is not limited thereto.

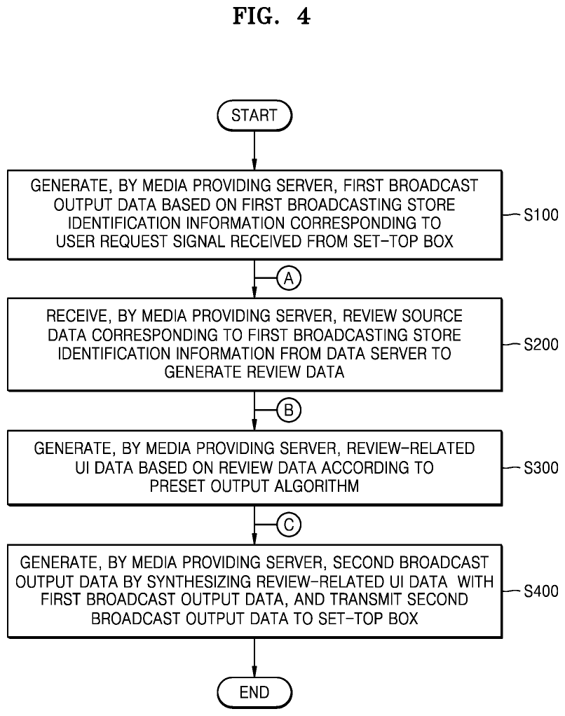

A method of providing review data for commerce content according to an embodiment will be described using FIGS. 3 and 4 together. FIG. 3 is a flowchart illustrating an operation of a broadcasting system according to an embodiment in terms of data transmission/reception between servers, and FIG. 4 is a flowchart illustrating an operation of a broadcasting system according to an embodiment. A method of providing review data for commerce content of the disclosure may include operations to be described later below.

Referring to FIG. 4, in operation S100, the media providing server 300 may generate first broadcast output data including first broadcast sales information. The first broadcast sales information is based on first broadcasting store identification information corresponding to a user request signal received from the set-top box 110.

In more detail, referring to FIG. 3, in operation S101, the media providing server 300 may receive a user request signal from the set-top box 110. Then, in operation S102, the media providing server 300 may transmit the first broadcasting store identification information corresponding to the user request signal to the data server 400. The data server 400 may search for first image identification information and first Detailed Product Information corresponding to the first broadcasting store identification information. In this case, the search operation may be performed by the media providing server 300. Thereafter, in operation S103, the media providing server 300 may receive at least one of the first image identification information and the first Detailed Product Information according to a result of the searching from the data server 400. Based on this, in operation S100, the media providing server 300 may generate the first broadcast output data based on at least one of the first image identification information and the first detailed product information, and in operation S104, may transmit the first broadcast output data to the set-top box 110.

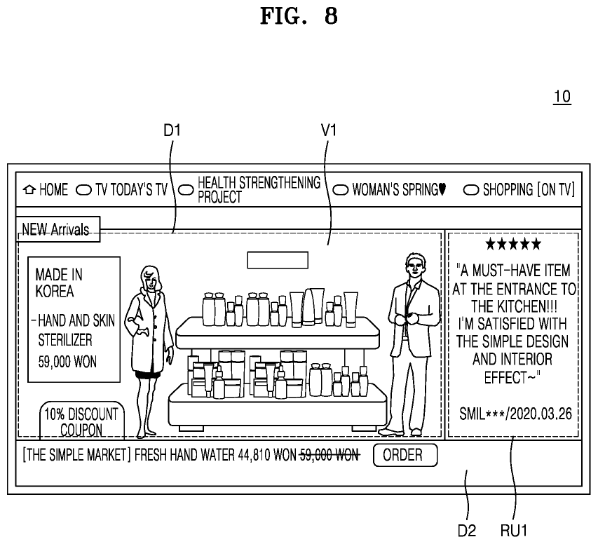

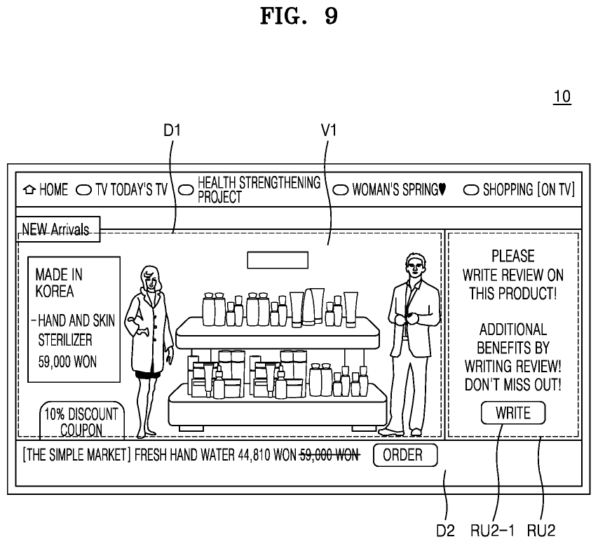

When there is first image identification information in the searching operation, the media providing server 300 may receive both the first image identification information and the first Detailed Product Information. The set-top box 110 may receive the first broadcast video corresponding to the first image identification information from the content transmission server 100. The media providing server 300 may generate first content data based on the first Detailed Product Information and transmit the first content data to the set-top box 110. The set-top box 110 may generate the first broadcast output data by combining the first broadcast video with the first content data. Examples of output data according to the embodiment are shown in FIGS. 8 and 9 to be described later.

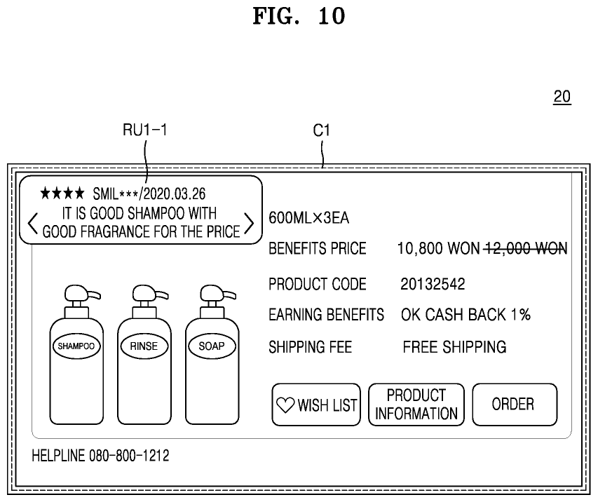

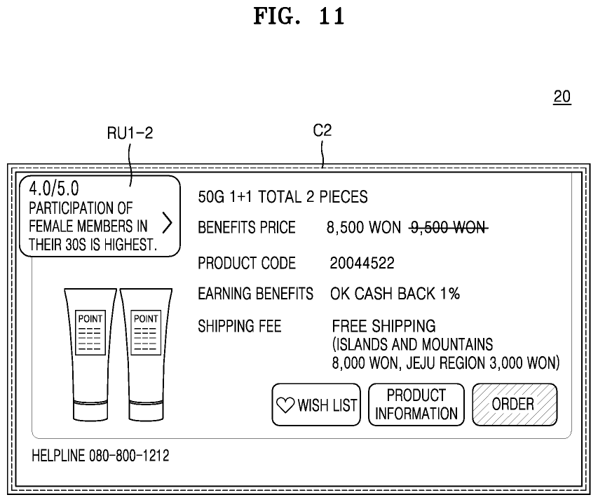

As another embodiment, when there is no first image identification information in the searching operation, the media providing server 300 may receive only the first Detailed Product Information from the data server 400, and may generate first content data based thereon. In this case, the first broadcast output data may be generated based on the first content data. Examples of output data according to the embodiment are shown in FIGS. 10 and 11 to be described later.

Referring back to FIG. 4, after generating the first broadcast output data in operation S100, in operation S200, the media providing server 300 may receive review source data corresponding to the first broadcasting store identification information from the data server 400 to generate review data.

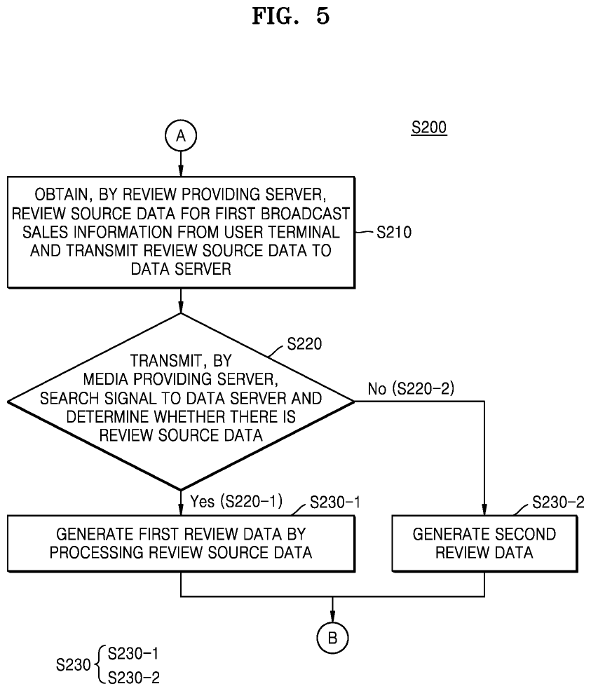

Hereinafter, operation S200 will be described using FIGS. 3 and 5 together. FIG. 5 is a flowchart illustrating in more detail operation S200 of generating review data according to an embodiment. Operation S200 of generating review data may include the following operations.

Hereinafter, ‘review source data’ may be various information about a specific product, an evaluation of a broadcasting store, a rating, and a user inputting such information. For example, the review source data may include at least one of user identification information, age information, gender information, and a user evaluation. The review data may include first review data and second review data according to whether there is the review source data.

In operation S210 of FIG. 5, the review providing server 500 may obtain review source data for the first broadcast sales information from the user terminal 501 and transmit the review source data to the data server 400. In other words, in operation S201 (FIG. 3), the review source data may be input to the review providing server 500 through the user terminal 501, and in operation S210, the review providing server 500 may transmit the review source data to the data server 400. In operation S211, the data server 400 may store and manage the received review source data. In this case, according to an embodiment, the review source data input from the user terminal 501 may be directly transmitted to the data server 400.

Referring back to FIG. 5, in operation S220, the media providing server 300 may transmit a search signal to the data server 400 and determine whether there is the review source data. In operation S230, the media providing server 300 may generate review data according to whether there is the review source data, and when there is the review source data in operation S220-1, the media providing server 300 may generate first review data by processing the review source data in operation S230-1, and when there is no review source data in operation S220-2, the media providing server 300 may generate second review data in operation S230-2.

The first review data may be generated to categorize each item of the review source data and classify the items according to a preset classification criterion, and to include at least one of rating information, a review participation generation ratio, a rating ratio by participation generation, and a user evaluation according to a result of the classifying.

Thereafter, referring back to FIGS. 3 and 4, in operation S300, the media providing server 300 may generate review-related UI data based on the review data according to a preset output algorithm based on absence or presence of the review source data. In operation S300, the review-related UI data may be generated by processing review data considering time code regarding a time when the review-related UI data is output preset on the data server 400 by the media providing server 300. Hereinafter, the review-related UI data may be overlaid with a broadcast video area and/or a content data area, and may be output in the form of a banner area or a pop-up window.

Thereafter, in operation S401, the media providing server 300 may generate second broadcast output data by combining the review-related UI data with the first broadcast output data, and in operation S400, may transmit the second broadcast output data to the set-top box 110.

Hereinafter, embodiments of operation S300 of generating review-related UI data will be described.

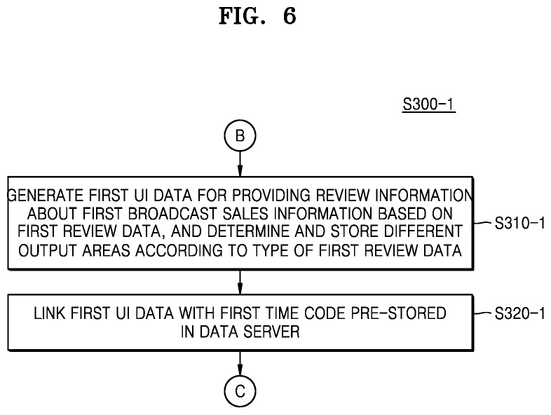

First, an embodiment of operation S300 will be described using FIG. 6 together with FIGS. 3 and 4. FIG. 6 is a flowchart illustrating operation S300-1 of generating review-related UI data according to an embodiment in more detail, and relates to an embodiment of generating UI data based on the above-described first review data.

First, in operation S310-1, first UI data for providing review information about first broadcast sales information may be generated based on the first review data, and different output areas may be determined and stored according to the type of the first review data. Thereafter, in operation S320-1, the first UI data may be linked with first time code pre-stored in the data server 400. Accordingly, the first UI data may be output on the above-described first broadcast output data at a time set according to the first time code. For example, an output point in time of the first UI data according to the first time code may be set to ‘when 10 seconds have elapsed from the time when the first broadcast output data is output’, ‘after specific content included in the first broadcast output data is output’, ‘at the same time as outputting the first broadcast output data’, and the like, but is not limited thereto, and may be variously set within a point in time at which the first broadcast output data is output.

The first UI data will be described with reference to FIG. 8 together.

Referring to FIG. 8, first UI data RU1 is shown in a right banner area. The first UI data RU1 includes review content such as rating information, a user evaluation (comment), a nickname as user identification information, and a review input date as input time information. An area in which each item of review content included in the first UI data is output may be determined differently as an upper portion, a middle portion, and a lower portion of the first UI data RU1, and an area where each item is output and a position where the first UI data RU1 is displayed on a display screen 10 are not limited to those shown in FIG. 8.

First UI data RU1-1 and RU1-2 according to another embodiment will be further described with reference to FIGS. 10 and 11 to be described later.

In more detail, operation S310-1 of generating the first UI data may be displayed to be automatically rolled according to the following operations.

First, the media providing server 300 may compare a first output size of first review data with a second output size of a first output area in which the first review data is output on the first UI data. In this case, the comparing may include comparing the first output size according to a font standard through which the first review data is output through the output device with the second output size of the first output area. For example, the first output size may be the overall horizontal size when the first review data is output, and the second output size may be a horizontal width of the first output area implemented on a display unit (not shown) of the output device 120, but it is not limited thereto. Various changes are possible within a range that can be displayed to be automatically rolled by dividing the first review data.

When a result of the comparing satisfies a preset criterion, the media providing server 300 may generate pieces of first sub-review data by dividing the first review data. The preset criterion is whether the first output size is greater than the second output size. When the first output size exceeds the second output size, pieces of first sub-review data may be generated. Thereafter, an output order may be assigned to each of the pieces of first sub-review data so that the pieces of first sub-review data are sequentially output through the output device 120.

For example, referring to FIG. 10 together, as the first review data on the first UI data RU1-1, the text “It is a good shampoo with a good fragrance for the price”, which is an example of evaluation data, is shown. Although not shown in the drawing, when a first output size of the text is greater than a second output size of an area in which the text is displayed on the first UI data RU1-1, the entire text data may not be visible in the area of the first UI data RU1-1 and is cut off. That is, the entire review content may not be provided to a user. Therefore, in this case, the first review data is divided into pieces of sub-review data to be sequentially output on the area of the first UI data RU1-1. For example, when the entire text of “It is a good shampoo with a good fragrance for the price” is not output in the area of the first UI data RU1-1, the media providing server 300 divides the first review data into pieces of first sub-review data including each text of “with a good fragrance for the price” and “It is a good shampoo”, and may output them to be automatically rolled in sequence.

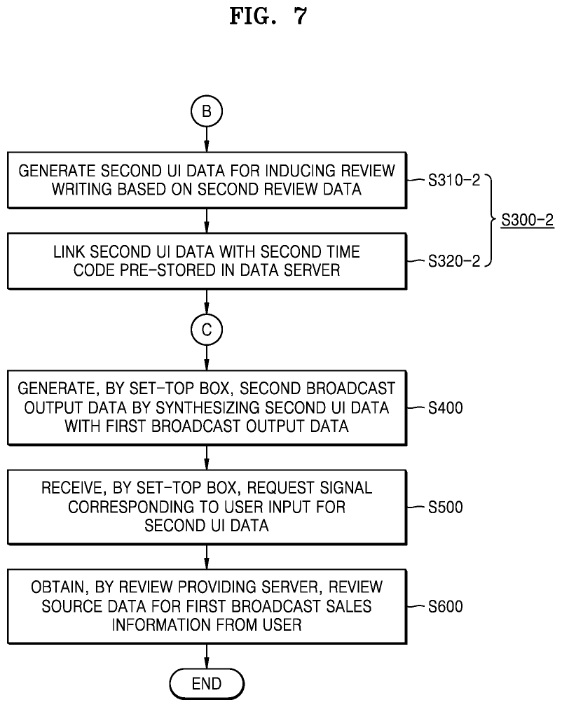

Next, another embodiment of operation S300 will be described using FIG. 7 together with FIGS. 3 and 4. FIG. 7 is a flowchart illustrating operation S300-2 of generating review-related UI data according to another embodiment in more detail.

First, in operation S310-2, the media providing server 300 may generate second UI data for inducing review writing based on second review data. For example, the second UI data may include visual data in which a message notifying a user that there is no review for the product or broadcasting store, a message inducing the review, etc. are implemented as text, images, or the like. The message content and output condition may be preset and stored in the data server 400. In addition, the media providing server 300 may generate the message as auditory data and output the message through the output device 120 together with the second UI data. Second UI data RU2 (see FIG. 9) will be described in more detail with reference to FIG. 9 to be described later.

Thereafter, in operation S320-2, the media providing server 300 may link the second UI data with second time code pre-stored in the data server 400. Accordingly, the second UI data may be output on the above-described first broadcast output data at a time set according to the second time code. Output timing of the second UI data according to the second time code may be set to be the same as output timing of the first UI data according to the first time code described above, or may be set differently in various ranges within a point in time at which the first broadcast output data is output.

Thereafter, in operation S400, second broadcast output data may be generated by combining the second UI data with the first broadcast output data, and subsequent operations to be described may be further included thereafter. In operation S500, the set-top box 110 may receive a request signal corresponding to a user input for the second UI data. In this case, the user input for the second UI data may mean to accept the writing of a review on first broadcast sales information. Referring to FIG. 9 together, the user input may be selecting second sub UI data RU2-1.

Thereafter, in operation S600, the review providing server 500 may obtain review source data for first broadcast sales information from the user. Accordingly, by the obtained review source data, the review source data stored and managed in the data server 400 in operation S211 may be updated. Thereafter, when the media providing server 300 receives a new user request signal for selecting the first broadcasting store identification information, in operation S200, review data is generated based on the updated review source data, in which case the review source data exists, and thus, first review data is generated. Thereafter, subsequent operations S300 and S400 may be performed.

Hereinafter, output data by a broadcast system according to an embodiment will be described with reference to FIGS. 8 and 9. FIGS. 8 and 9 are examples of output data for commerce content having a broadcast video. FIGS. 8 and 9 are exemplary views of output data for commerce content for broadcasting according to different embodiments.

FIGS. 8 and 9 show the display screen 10 of the output device 120 at one point in time. The display screen 10 may be a screen displayed on a display unit (not shown) of the output device 120.

Referring to FIGS. 8 and 9, the display screen 10 may include a first area D1 in which a broadcast video V1 corresponding to image identification information is displayed and a second area D2 in which content data including review content is displayed. The second area D2 may include content data for displaying various broadcast sales information such as the Detailed Product Information described above adjacent to or around the first area D1. In this case, the second area D2 may further include review-related UI data RU1 and RU2 for displaying review content. First broadcast output data may be generated by combining the broadcast video V1 and the content data using the set-top box 110 and the media providing server 300. Simultaneously or after this, the media providing server 300 may generate the review-related UI data RU1 and RU2, and may synthesize them with the first broadcast output data to generate second broadcast output data (the display screen 10 in FIGS. 8 and 9).

FIG. 8 is an example in which the first UI data RU1 generated based on first review data is output, and FIG. 9 is an example in which the second UI data RU2 generated based on second review data is output. The review-related UI data RU1 and RU2 are the same as those described above with reference to FIGS. 6 and 7, and thus, repeated descriptions thereof are omitted or simplified.

The first UI data RU1 shown in FIG. 8 may include various review content of existing users of the product/broadcasting store described above. For example, when a first broadcasting store indicated by first broadcast output data shown in FIGS. 8 and 9 is a new product store, the first review data may include at least one of the most recently registered product review and the highest rated product review for a product of the first broadcast store, and the first UI data RU1 may display at least one of them. In this case, for example, the data server 400 may obtain time data from the current time point to the time of each product review registration from among the first review data, may determine a product review having the shortest time data, and may transmit information about the product review to the media providing server 300. Then, the media providing server 300 may generate the first UI data RU1 based on the received product review information and output the first UI data RU1 through the set-top box 110.

Referring to FIG. 9, the second UI data RU2 is shown in a right banner area. As described above, the second UI data RU2 may be data generated based on second review data when a product review is not registered with respect to a corresponding broadcasting store. The second UI data RU2 is a message for inducing writing a review, and may include text such as “Please input a review of the product!”. In addition, the second UI data RU2 may include the second sub UI data RU2-1 that can be moved to a review writing field through a mobile app by inducing a user input. The user input is to select the second UI data RU2 (e.g., the second sub UI data RU2-1), and may mean to accept the writing of a review on first broadcast sales information. A user may provide new review data to the review providing server 500 or the data server 400 through the output device 120 or a separate user terminal by selecting the message for inducing.

Hereinafter, output data by a broadcast system according to another embodiment will be described with reference to FIGS. 10 and 11. FIGS. 10 and 11 are examples of output data for commerce content without a broadcast video. FIGS. 10 and 11 are exemplary views of output data for commerce content for non-broadcasting according to different embodiments.

FIGS. 10 and 11 show a display screen 20 of the output device 120 at one point in time. The display screen 20 may be a screen displayed on a display unit (not shown) of the output device 120.

Referring to FIGS. 10 and 11, content data C1 and C2 related to non-broadcast products are displayed on the display screen 20. The examples of FIGS. 10 and 11 are outputs for a non-broadcast product/broadcast store without a broadcast video, and the same principle as that described in the broadcast product with a broadcast video described above may be applied with respect to an output of review content. The content data C1 and C2 may be displayed entirely on the display screen 20, and the first UI data RU1-1 and RU1-2 may be output in the area of the content data C1 and C2.

Referring to FIGS. 10 and 11 together, the first UI data RU1-1 and RU1-2 according to another embodiment are shown. The first UI data RU1-1 of FIG. 10 may include review content such as rating information, a nickname, a review input date, and a user evaluation. Each item of the review content may be output to different output areas on a first UI. The first UI data RU1-2 of FIG. 10 is an example including review content such as rating information and participation rate by generation. The rating information may be displayed as stars, as shown in FIGS. 8 and 10, or as a score (number), as shown in FIG. 11, but it is not limited thereto, and may be variously changed within a range that may indicate users' ratings.

The media providing server 300 may generate first broadcast output data based on content data generated based on Detailed Product Information. Simultaneously or after this, the media providing server 300 may generate the review-related UI data RU1-1 and RU1-2, and may synthesize them with the first broadcast output data to generate second broadcast output data (the display screen 20 in FIGS. 9 and 10).

As such, according to embodiments, by providing review content for commerce content, consumers may be effectively induced to make a purchase, such as enhancing a user's purchase desire, providing various information about a product before a purchase and use, helping consumers to make a purchase decision, and at the same time improving the reliability of the product. In addition, in TV broadcasting applications where visual elements are important, by providing review content in a variety of ways, the evaluation of existing users acts as an important factor in a purchasing decision of potential consumers, which has the advantage of enabling effective advertisement for commerce content.

Furthermore, content data including the broadcast video V1 and review content are provided from different servers outside the set-top box 110, thereby distributing a data load on a network.

According to embodiments, by providing review content for commerce content, a user's desire to make a purchase may be enhanced, and by providing users' experiences and reviews of products that have already been purchased, various information about products before a purchase may be provided. In addition, there is an advantage of helping consumers to make a decision while providing a sense of trust in a product and encouraging consumers to purchase.

Furthermore, in a TV broadcasting application that values visual elements, by providing review content in a variety of display methods, the evaluation of consumers who have tried the product before use, which is difficult to know the performance and effect of, may act as an important factor in making product purchase decisions, and thus, effective advertisement for commerce content is possible.

Moreover, the content data including the broadcast video and review content are provided from different servers outside the set-top box, thereby distributing a data load on a network.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of providing review data for commerce content, the method comprising:
generating, with a media providing server, first broadcast output data including first broadcast sales information based on first broadcasting store identification information corresponding to a user request signal received from a set-top box;
receiving, at the media providing server, review source data corresponding to the first broadcasting store identification information from a data server and generating review data;
generating, with the media providing server, review-related user interface (UI) data based on the review data according to a preset output algorithm based on absence or presence of the review source data; and
generating, with the media providing server, second broadcast output data by combining the review-related UI data with the first broadcast output data, and transmitting the second broadcast output data to the set-top box.

2. The method of claim 1, wherein
the review data comprises first review data and second review data based on absence or presence of the review source data in the data server; and
generating the review data further comprises:
obtaining, with a review providing server, the review source data for the first broadcast sales information from a user terminal and transmitting the review source data to the data server;
determining, with the media providing server, absence or presence of the review source data by transmitting a search signal to the data server; and
generating, by the media providing server, the first review data by processing the review source data based on presence of the review source data, and generating the second review data based on absence of the review source data.

3. The method of claim 2, wherein:
the review source data further comprises a set of information that include user identification information, age information, gender information, input time information, a user evaluation, or a combination thereof; and
generating the first review data further comprises:
categorizing each information of the review source data and classifying each information according to a preset classification criterion; and
generating the first review data including rating information, a review participation generation ratio, a rating ratio by participation generation, a user evaluation, or a combination thereof, according to classification of each information.

4. The method of claim 2, wherein:
generating the review-related user interface (UI) data further comprises:
generating first UI data that provides review information about the first broadcast sales information based on the first review data, and determining and storing different output areas according to a type of the first review data; and
linking the first UI data with first time code pre-stored in the data server such that the first UI data is output as the first broadcast output data at a time set according to the first time code.

5. The method of claim 4, wherein
generating of the first UI data further comprises:
comparing the first review data with a first output area in which the first review data is displayed on the first UI data;
generating pieces of first sub-review data by slicing the first review data when a first output size of the first review data exceeds a second output size of the first output area based on comparison;
assigning an output rank to each of the pieces of first sub-review data; and
sequentially outputting, based on an assigned output rank, the pieces of first sub-review data through an output device.

6. The method of claim 2, wherein
generating the review-related user interface (UI) data further comprises:
generating second UI data for prompting review writing based on the second review data; and
linking the second UI data with second time code pre-stored in the data server such that the second UI data is output as the first broadcast output data at a time set according to the second time code.

7. The method of claim 6, further comprising:
after generating the second broadcast output data:
receiving, at the set-top box, a request signal corresponding to a user input for the second UI data; and
obtaining, with the review providing server, review source data for the first broadcast sales information from the user.

8. The method of claim 1, wherein:
generating the first broadcast output data further comprises:
transmitting, with the media providing server, the first broadcasting store identification information to the data server;
searching at the data server, first image identification information and first detailed product information corresponding to the first broadcasting store identification information;
receiving, at the media providing server, the first image identification information, the first detailed product information, or both according to a result of the searching from the data server; and
generating, by the media providing server, the first broadcast output data based on the first image identification information, the first detailed product information, or both.

9. A computer program stored on a computer-readable recording medium for executing the method of claim 1 using a computer.

10. A commerce content broadcasting system comprising:
a media providing server including a processor and a communication unit capable of communicating with a set-top box connected to an output device; and
a data server communicating with the set-top box and the media providing server,
wherein the processor is configured to:
generate first broadcast output data including first broadcast sales information based on first broadcasting store identification information corresponding to a user request signal received from the set-top box;
receive review source data corresponding to the first broadcasting store identification information from the data server and generate review data;
generate review-related UI data based on the review data;
generate second broadcast output data by combining the review-related UI data with the first broadcast output data; and
output the second broadcast output data to the set-top box via the communication unit.

11. The commerce content broadcasting system of claim 10, wherein
the review data comprises first review data and second review data based on presence or absence of the review source data in the data server.

12. The commerce content broadcasting system of claim 11, further comprising:
a review providing server communicating with the set-top box, the media providing server, and the data server;
wherein the review providing server obtains the review source data for the first broadcast sales information from a user terminal and transmits the review source data to the data server.

13. The commerce content broadcasting system of claim 11, wherein the processor is further configured to:
transmit a search signal to the data server to determine presence or absence of the review source data;
generate the first review data by processing the review source data based on presence of the review source data; and
generate the second review data based on absence of the review source data.

14. The commerce content broadcasting system of claim 11, wherein:
the review source data comprises user identification information, age information, gender information, input time information, a user evaluation, or a combination thereof; and
the processor is further configured to:
categorize each information of the review source data and classify each information according to a preset classification criterion; and
generate the first review data including rating information, a review participation generation ratio, a rating ratio by participation generation, a user evaluation, or a combination thereof, according to classification of each information.

15. The commerce content broadcasting system of claim 12, wherein:
the processor is further configured to:
generate first UI data for providing review information about the first broadcast sales information based on the first review data, determine and store different output areas according to a type of the first review data; and
link the first UI data with first time code pre-stored in the data server such that the first UI data is output as the first broadcast output data at a time set according to the first time code.

16. The commerce content broadcasting system of claim 15, wherein:
the processor is further configured to:
compare the first review data with a first output area in which the first review data is output on the first UI data;
slice the first review data to generate pieces of first sub-review data when a first output size of the first review data exceeds a second output size of the first output area;
assign an output rank to each of the pieces of first sub-review data; and
sequentially output, based on an assigned output rank, the pieces of first sub-review data through an output device.

17. The commerce content broadcasting system of claim 15, wherein:
the processor is further configured to:
generate second UI data for prompting review writing based on the second review data; and
link the second UI data with second time code pre-stored in the data server such that the second UI data is output as the first broadcast output data at a time set according to the second time code.

18. The commerce content broadcasting system of claim 17, wherein:
after the processor generates the second broadcast output data,
the set-top box receives a request signal corresponding to a user input for the second UI data; and
the review providing server obtains review source data for the first broadcast sales information from the user.

19. The commerce content broadcasting system of claim 10, wherein,
in the first broadcast output data,
the processor transmits the first broadcasting store identification information to the data server;
the data server searches for first image identification information and first detailed product information corresponding to the first broadcasting store identification information; and
the processor receives the first image identification information, the first detailed product information, or both from the data server, and generates the first broadcast output data based on the first image identification information, the first detailed product information, or both.
